(19) United States
(12) Patent Application Publication
(10) Pub. No.: US 2007/0130546 A1
(43) Pub. Date: Jun. 7, 2007

(54) CONTEXT BASED NAVIGATION WITHIN A BROWSER APPLICATION

(76) Inventors: Robert Harris, Christchurch (GB); Kevin Russell, Winchester (GB); William Yates, Portsmouth (GB)

Correspondence Address: IBM CORPORATION;INTELLECTUAL PROPERTY LAW, 11400 BURNET ROAD, AUSTIN, TX, 78758, US

(21) Appl. No.: 11/562,624

(22) Filed: Nov. 22, 2006

(30) Foreign Application Priority Data
Nov. 26, 2005 (GB) 0524164.1

(51) Int. Cl. G06F 3/00; G06F 17/00

(52) U.S. Cl. 715/854; 715/501.1

(57) ABSTRACT

A context based navigation component for navigating from a first page to a second page within a browser application, the context based navigation component comprising: a call back function for receiving an instruction to navigate to a second page from an action button operating within the browsing application; a state management component for determining the attributes of the first page and in response to the determined attributes identifying which second page to navigate to; and a generation component for generating an address of the determined second page and assigning the generated address to the action button.

### FIELD OF THE INVENTION

The invention relates to the field of Internet browsing. In particular, the invention relates to the field of context based web page navigation.

### BACKGROUND OF THE INVENTION

Browser applications are used to retrieve web pages located on web servers for viewing at a client device. Prior art web browsers include functionality to aid page navigation during a user session. One example of this type of functionality is the ability to re-view a previously displayed web page.

The ‘re-view a previously displayed web page’ functionality is controlled by forward and back buttons located on the tool bar of the browser. These buttons often appear as back and forward pointing arrows in a fixed position on the browser's display area. When a page is accessed by the browser the page is typically stored in a local cache. In order to access a previously viewed web page by either the forward button or the back button, the forward or back button accesses the local cache and retrieves the appropriate web page. Thus, the browser's cache of previously viewed pages allows the user to navigate to pages already viewed within their current browsing session.

Internet applications which are executed using a browser for user input and output are accessed through the HTTP protocol which is known in the art as a stateless protocol. However, prior art internet applications require the browser to send ‘state’ information with each request in order for the application to maintain information about the user's session, therefore providing relevant information to the user. However, the application being executed cannot rely on any consistent operational state being valid throughout the lifetime of a user interaction. This often means that a page stored in the browser's cache becomes invalid because it contains out of date information. Attempts to redisplay a page will result in a navigational error response. Such navigational errors range from the page not redisplaying to inaccurate or invalid information being displayed.

Existing prior art solutions attempt to solve the problem by using a browser in ‘kiosk mode’. Kiosk mode involves ignoring the problem of navigational errors by removing the navigation buttons from the browser interface. The removal of the navigational buttons presents usability problems for users, namely; that is they are not able to use forward and back buttons to correct a mistake.

Another instance where prior art navigational buttons fail to provide useful functionality is when the user is browsing a page which is within a larger sequence of pages. Examples of sequential chains are in search engine result pages. Due to the large number of potential results, the results are split into several pages. Each page often contains a link to at least the next page to be viewed and the previous page. These commonly appear in the browser as:

<PREV> <1> <2> <3> <4> <5> <6> <NEXT>

This method of linking to the next and/or previous page in the chain is in direct opposition to the normal function of the browser back and forward buttons. A user at the first page in the chain at the start of a browsing session wishing to navigate to the ‘next’ page may attempt to use the ‘forward’ browser navigation button. However, due to the operation of the browser cache this functionality will not be available (as the page has not been viewed and thus the page is not in the cache). Therefore, the user has to use the links provided on the page. Similarly, if the user uses the links to navigate directly to the nth page in the chain and then wishes to access the previous page in the chain, the backward browser control does not provide this functionality. For example, after viewing pages 1, 2, 9 the use of the prior art back button will redisplay page 2 when page 8 is really required.

Clearly, these approaches are unsatisfactory for normal users. In the case of disabled users the situation is untenable. Visually restricted users have to use screen readers to examine the web page displayed in the browser and thus need some uniform and clear way of navigating through a set of web pages.

Thus there is a need within the prior art for an improved method of navigation using the forward and back navigation buttons.

### SUMMARY OF THE INVENTION

According to a first embodiment, the present invention comprises a context based navigation component for navigating from a first page to a second page within a browser application, the context based navigation component comprising: a call back function for receiving an instruction to navigate to a second page from an action button operating within the browsing application; a state management component for determining the attributes of the first page and in response to the determined attributes identifying which second page to navigate to; and a generation component for generating an address of the determined second page and assigning the generated address to the action button.

Advantageously, the present invention provides for determining, at the moment a user selects an action button (for example, a forward or back button), the next logical page to navigate to. In order to achieve this advantage, the present invention determines the workflow logic of the web site in which the user is browsing. Status information is gathered from the page the user is browsing, for example, which data entries fields the user has selected or entered data into—i.e. determining that the user has selected the third radio button and thus page 2 needs to be displayed rather then page 4.

Depending on the data entry attributes, the next logical page is located. This may be by either requesting the page from the server which stores the requested page or by parsing a workflow map, which describes the navigation paths that can be taken from each page depending on data input into the first page.

Hence, advantageously, a user is able to navigate through a web site, whether this is an HTML form or a Java application forming an on-line banking site, logically. A user will no longer be logged out of their, for example, on-line banking application, because of a mis-match of state between the browser and the website. The user is also able to take advantage of forward and back navigation buttons where normally the forward and back buttons would be disabled i.e. when a website is operating in kiosk mode. Each time the user selects a navigation action button, the address of the next logical page is generated dynamically and attached to the requesting navigation action button.

Advantageously, the action buttons have their properties set by the page being displayed—not simply by the position in a sequence of already visited pages.

Preferably, the present invention comprises a context based navigation component wherein the action button is a forward or back button.

Preferably, the present invention comprises a context based navigation component wherein the state management component determines the attributes of the first page by requesting status information from the call back function.

Preferably, the present invention comprises a context based navigation component wherein the status information comprises the identity of a type and context of data input into the first page.

Preferably, the present invention comprises a context based navigation component wherein the state management component further comprises determining a workflow of a website in order to determine a second page to navigate to.

Preferably, the present invention provides a context based navigation component wherein the workflow comprises a workflow map depicting a plurality of navigation paths to be navigated to.

Preferably, the present invention comprises a context navigation component wherein if the workflow map does not contain a required navigation path to a second page, then the state management component transmits a request to a server which stores the first page to request the communication of the second page.

Preferably, the present invention comprises a context navigation component further comprising a notifying component for notifying the browser application of an absent data entry of a data entry field of the first page such that the state management component is unable to determined the second page to navigate to until the absent data entry has been remedied.

Viewed from a second aspect the present invention comprises a method for context based navigation for navigating from a first page to a second page within a browser application, the context based navigation function comprising: receiving an instruction to navigate to a second page from an action button operating within the browsing application; determining the attributes of the first page and in response of the determined attributes identifying which second page to navigate to; and generating an address pertaining to the determined second page and assigning the generated address to the action button.

Viewed from a third aspect the present invention provides a computer program product directly loadable into the internal memory of a digital computer, comprising software code portions for performing the steps of the present invention as described above when said steps are run on a computer.

### BRIEF DESCRIPTION OF THE DRAWINGS

Embodiments of the invention are described below in detail, by way of example only, with reference to the accompanying drawings in which:

FIG. 1 is a block diagram of a heterogeneous computing environment in which a preferred embodiment of the invention may be implemented;

FIG. 2 is a block diagram showing the components of a web server as is known in the art;

FIG. 3 is a block diagram showing the components of a web browser in which a preferred embodiment of the invention may be implemented;

FIG. 4 is a block diagram showing the components of the context navigation component in accordance with a preferred embodiment of the invention;

FIG. 5 is a block diagram showing a workflow map in accordance with a preferred embodiment of the invention;

FIG. 6 shows a block diagram of the web server of FIG. 3 comprising a site map component in accordance with a preferred embodiment of the present invention; and

FIG. 7 is a flow chart showing the operational steps of the context navigation component in accordance with a preferred embodiment of the invention.

### DETAILED DESCRIPTION OF THE INVENTION

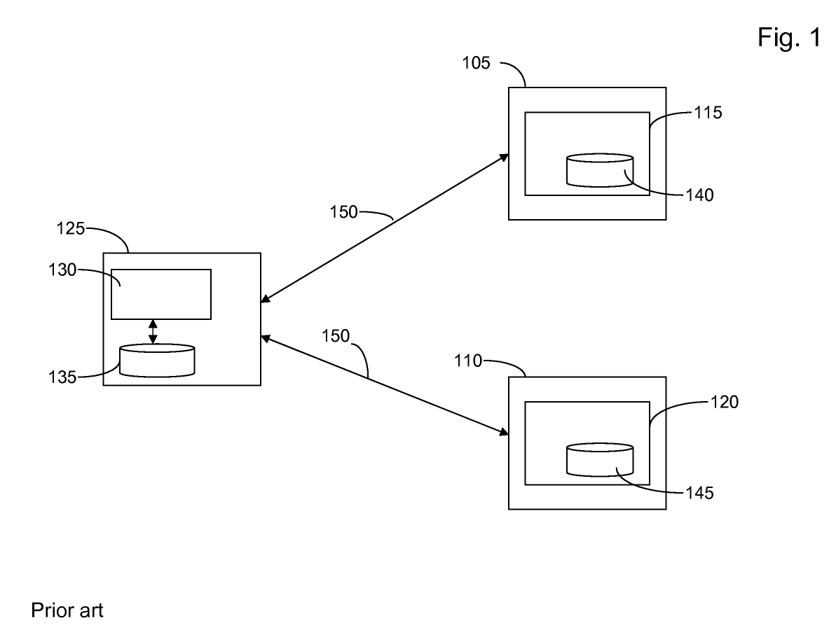

FIG. 1 shows a number of components of a data processing network, including a web server 130 running on a mainframe server 125 that is connectable for communication with client computers 105, 110. The client computers 105, 110 are running a web browser program 115, 120 and comprise a data store 140, 145 for storing previously viewed web pages. As is known in the art, a web browser 115, 120 is an application program which is capable of sending Hypertext Transfer Protocol (HTTP) requests to web servers to access information on the World Wide Web.

Each of the client computers 105, 110 and the server 125 may be remote from each other within a network 150, such as, if the invention is used for searching for desired web pages on computers connected to the Internet and accessible via the World Wide Web. The client computers 105, 110 and the server 125 could equally be components of a local network or intranet.

The client computer 105, 110 is not limited to a particular type of data processing apparatus, and may be a conventional desktop or lap-top personal computer, a personal digital assistant (PDA) or another specialized data processing device which is capable of running a client requester program. The client computers 105, 110 may connect to a network of data processing systems via wireless or hard-wired connections. Similarly, the server 125 can be any data processing apparatus which is capable of running a web server 130, directory server or similar server program and a data store 135 for storing a plurality of web pages. Software-implemented elements of the embodiment described in detail below are not limited to any specific operating system or programming language.

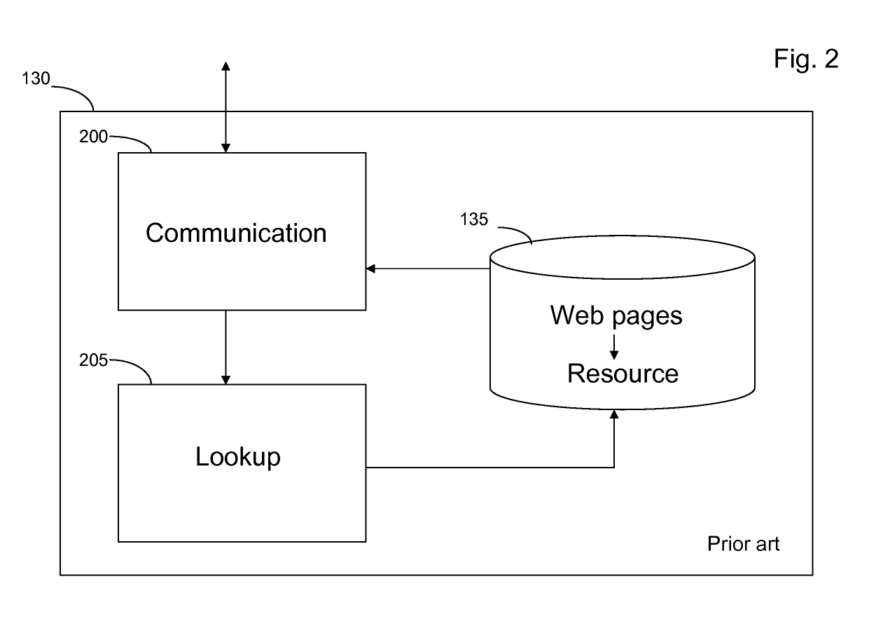

Referring to FIG. 2 the web server 130 comprises a number of components in order to serve web pages requested from client devices. The web server 130 comprises a communication component 200 for receiving requests from client devices 105, 110 and for sending replies in the form of requested web pages and other resources to the requesting client device 105, 110, a data store 135 for storing web pages and a lookup component 205 for parsing a client request in order to locate in the data store the requested web page. Each of these components will now be explained in turn.

The communication component 200 receives requests for resources from requesting client devices and is operable with an HTTP protocol. The request comprises the URL of the requested resource. The communication component 200 communicates the request for the resource to the lookup component 205. A lookup is performed on the URL to identify the pathname which identifies the location of the requested resource in the data store. The lookup component 205 sends a request to the identified location and retrieves the requested resource from the data store 135. The requested resource is transmitted to the communication component 200 by the lookup component 205 for communicating across the network 150 to the requesting device 105, 110.

The data store 135 comprises a number of web pages and other resources such as images, audio files and video images for transmitting to a requesting client device 105, 110. Each web page is made up of HTML code. The HTML code specifies how text, images and other resources are laid out on the web page.

An example of a basic HTML web page displaying the text ‘Hello World’ in bold is shown in example 1.

### EXAMPLE 1

EXAMPLE 1
<html><head><title> Hello world </title>
<meta http-equiv=‘Content-Type’ content=‘text/html;
charset=iso-8859-15’>
</head>
<body><b> Hello world </b></body>
</html>

HTML comprises tags for specifying the text and images to be displayed on a web page and the location of the text and images on the web page. HTML tags come in pairs—each tag pair comprising a start tag and a closing tag i.e. <></>. More interactive and dynamic functionality may be incorporated into an HTML web page by incorporating a scripting tag into the HTML, for example <script></script>. Applets may be called within the script tags, for example, <script language=“javascript” arc=“pcgi-bin/navigation.js”></script>. Thus calling a javascript program called navigation.js. JavaScript is a registered trademark of Netscape Corporation in the US and other countries. Java is a registered trademark of Sun Microsystems in the US and other countries.

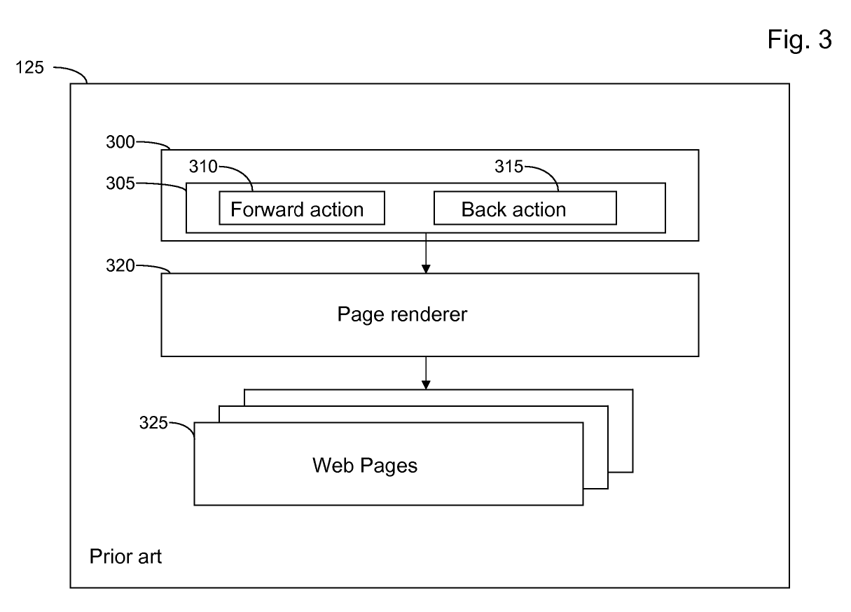

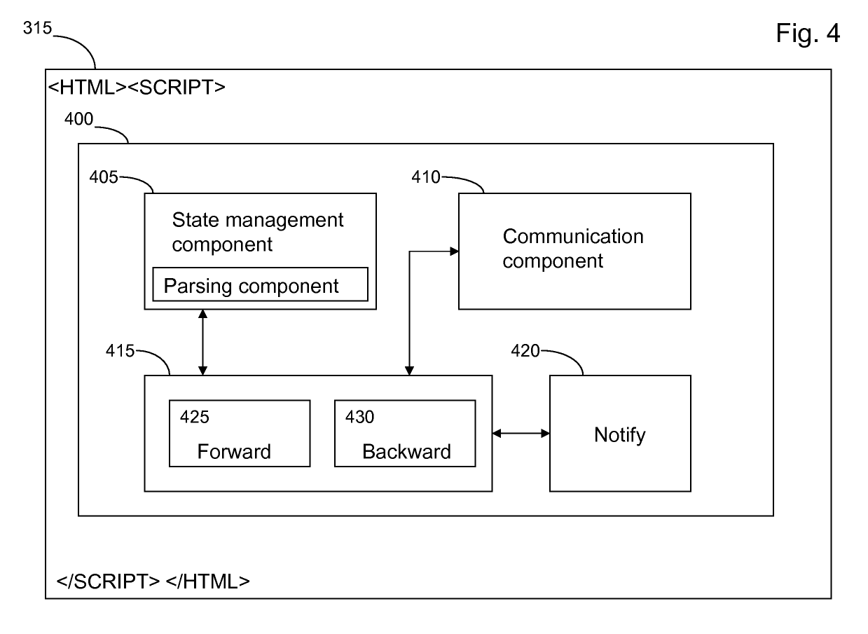

FIG. 3 details the main components of a known prior art browser 125. The components comprise a user interface 300 comprising a display window and an action bar 305 comprising a number of buttons that can be selected by the user for performing a number of actions with respect to browsing web pages 325, for example, forward and back buttons for browsing previously displayed web pages 325. A URL is typed in to the address bar located on the action bar 305 of the browser window 115, 120. The browser 155, 120, using the HTTP protocol transmits a request to the web server 130 named in the URL requesting a requested resource. The web server 130 transmits the request back to the browser 115, 120 for rendering by a page renderer component 320. Forward and back buttons are then used by the user to navigate through previously viewed web pages. If the user has just started a browsing session, the forward 310 and back buttons 315 are greyed out until the user has visited another web page 325 and it is only at that point URL's are attached to the forward and back buttons in order to provide navigation functionality of previously viewed web pages 325. With reference to FIG. 4, in order to provide enhanced navigational functionality the present invention provides a context navigation component 400 which uses, in a preferred embodiment, uses the functionality offered by HTML.

The context navigation component 400 provides means for context based navigation for determining, within a user's browser session, the web page the user is currently browsing and determining the next web page the user can navigate to; whether this is by navigating forward or by navigating backwards.

In order to achieve this functionality the context navigation component 400 gathers information about the workflow logic of the user's browsing session which comprises information about the web page 325 the user is currently browsing and the web pages 325 the user can navigate to next. In a simple scenario the next web page to navigate to may just be the next logical web page 325 . I.e. if a web page is an article about a current news story and the article is displayed over two pages—the next logical web page 325 is the web page 325 which is displaying the next part of the article. In a more complicated scenario, a user may be browsing a number of web pages 325 which ‘make up’, for example, a theory driving test. In order to progress through the theory driving test the user is required to select a number of options, via radio buttons. Depending on the radio button selected the user is presented with a series of further options. Hence a hierarchical workflow of web pages 325 exists. Thus in this scenario the next logical web page to navigate to is the web page that is relevant to a selected option. For example, if the user selected radio button three and radio button three was an answer to a multiple choice question and the selected answer was the correct answer, the next logical page to navigate to may be a ‘congratulations—correct answer’ page. But if radio button three was in fact the wrong answer the next logical page to navigate to may be a ‘sorry, wrong answer—better luck next time’ page.

For clarity the term browsing session will be used to mean, a series of web pages a user is browsing through or an application that a user is browsing through. To illustrate this further, a series of web pages 325 may comprise a series of on-line forms browsed in order to obtain a quote for motor insurance from an insurance company and an application may comprise, for example, a Java applet forming an on-line banking application where a user manages financial affairs on-line. when the browser renders, via the web page rendering component 320, the requested web page 325 and the functionality is actioned via the forward 310 and back 315 buttons located on the action bar 305 of the browser window 300.

The browser 300 detects the selection of a forward 310 or back 325 button by detecting a GUI event within the browser window 300, for example, by detecting an ‘on click mouse’ event in the browser window 300. Depending on the type of button clicked a message is transmitted from the button to the context navigation component 400 embedded within the scripting tag of the HTML Page. The context navigation component 400 may be embedded directly within the scripting tag or alternatively a link to the context navigation component may be embedded within the scripting tag, thus ‘calling’ the context navigation component 400 from an external data store.

Moving onto FIG. 4, the components of the context navigation component 400 are shown, in accordance with a preferred embodiment of the present invention.

The components comprise a state management component 405 for understanding the workflow logic of a user's browsing session, a communication component 410 for sending and receiving messages from a web server 130, a navigation component 415 comprising a forward 425 and a back 430 navigation component and a notify function 420 for notifying the user of a data entry field that has not been completed on the page. For example, if a user has requested to transfer fifty pounds from bank account A to bank account B but did not specify the day in which the transfer is to be actioned, the user would be informed of the requirement to enter the missing data into the relevant data entry field.

Each of these components will now be explained in turn. The navigation component 415, as previously stated, comprises a forward navigation component 425 and a back navigation component 430, the forward navigation component 425 receives messages from the forward button 310 located on the browser's tool bar 305 and the back navigation component 430 receives messages from the back button 315 located on the browser's tool bar 305. Of course, as is known in the art, messages may be received from menu bar actions offering forward and back navigational functionality.

A received message comprises information, such as, to which forward 310 or back button 315 has been selected. The respective forward 310 or back button 315, on receipt of a message, generates a call function to the state management component 405 asking for the status and the workflow attributes in respect of the current web page which is being browsed. On receipt of this information the respective forward 425 or back navigation component 430 generates a URL for attaching to the respective forward 310 or back button 315 located on the browser's tool bar. Thus, allowing the user to navigate to a previous web page or the next web page within the logical workflow of the web page they are viewing.

The state management component 405 interfaces with the navigation component 415 to receive instructions pertaining to the action a user wishes to perform and interfaces with the communication component 415 to request workflow information from one or more servers 130.

On receiving an instruction from the forward 425 or back navigation component 430, the state management component 405 extracts from the instruction the URL of the web page the user is currently viewing. The state management component 405 parses the URL to determine the location of the web page 325 on a server 130 the user is currently viewing. On determination of this information the state management component 405 creates a payload comprising a request for the next web page to be viewed within the workflow sequence.

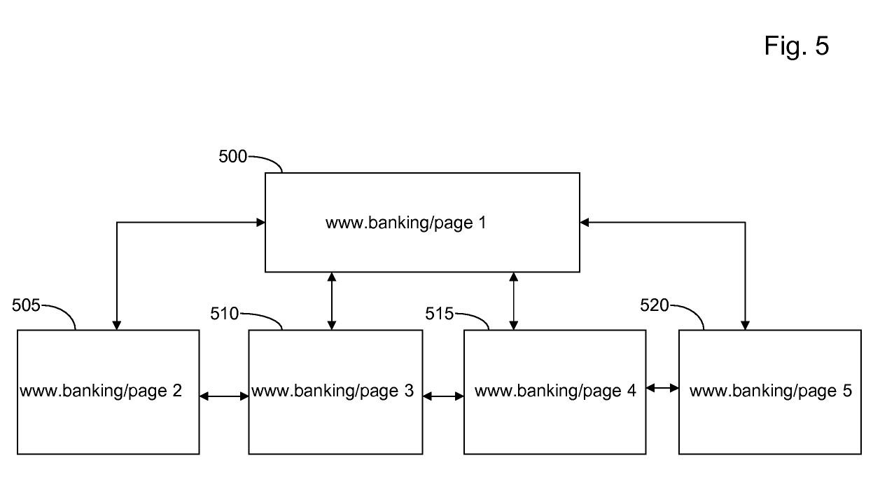

The payload is communicated to the communication component 410 for transmitting across the network 150 to the server 130 where the currently viewed web page is stored. The server 130 transmits a reply payload to the state management component 405, via the communication component 410, with the requested workflow information. The reply payload may comprise a URL for the next logical page, or, for the next n number of pages. For example, the server may return a workflow map for all given combinations of navigateable web pages 325 within the workflow sequence. An example of a workflow map 525 is shown in FIG. 5. The workflow map 525 comprises each web page or node contained within a web site. Thus, if this is the first time the user has browsed this particular web site or they have cleared their browser cache—the forward button would, in the example of a prior art forward button, be greyed out and hence unusable. But, in this instance, the state management component 405 traverses the workflow map 525 and can determine the next web page 325 to navigate to depending on whether the back 310 or forward button 315 has been selected.

On locating the next web page to navigate to the state management component 405 generates a URL and attaches the URL to the functional attributes of the respective forward 310 or back 315 button. Thus, if the URL is being attached to the functional attributes of the forward button, the forward button is no longer greyed out and can be used for navigating to the next page within the workflow sequence.

Therefore, working through FIG. 5, if the user enters the web site or starts using an application (such as on-line banking) at page 1 500, the state management component 405 detects the next web page in the workflow sequence as page 2 505 and a URL is generated for page 2 505 and attached to the functional attributes of the forward button 310. Likewise, because page 1 500 was the last page browsed by the user, a URL is generated for page 1 500 and attached to the functional attributes of the back button 315. Now both forward 310 and back buttons 315 are operational with browsing context URL's. As the user moves to page 3 510, a URL is generated for Page 2 505 and attached to the functional attributes of the back button 315 and a new URL is generated for page 4 515 and attached to the forward button 310 and so on. This sequence of steps is followed as the user continues to browse through the web site. Hence, in the prior art, if the application was for example, an on-line banking application and the back button 315 was selected, the user would be taken out of their on-line banking application to the bank's homepage. This also means the user is logged out of the on-line banking application. But using the context navigation component 400 the user can navigate forwards and backwards within their on-line banking application without the disadvantage of leaving their on-line banking user session.

Returning to FIG. 4, the state management component 405 comprises a parsing component 435 for parsing the workflow map 525 to locate the next navigateable web page 325. The workflow 525 map may comprise a hierarchical tree structure depicting the workflow logic of the navigateable pages within the user's current browsing session or for a particular web site. The parsing component 435 traverses the workflow map 525 until a next level node is located within the map 525. The next level node represents the next page. If the instruction is received from the forward navigating component 425 the parsing component 435 will traverse the workflow map 525 to a lower level node in the map 525 and if the instruction is received from the backward navigating component 430 the parsing component 435 will backtrack through the workflow map 525 and navigate back to the next higher level node. If the user is browsing web pages 325 which require options to be selected and the selected option determines the next web page to be displayed, the parsing component 435 is informed of the selected option and traverses the workflow map 525 filtering out nodes which do not apply to the selected option and thus returning the name and location of the next logical web page 325.

The state management component 405 receives the name and location of the next logical web page to navigate forward or backward to. The name and location is sent to the requesting forward button or back button.

The requesting forward 310 of back button 315 receives the name and location from the state management component 405 and generates a URL from this information for attaching to the attributes of the requesting button 310, 315. The requesting forward 310 or back button 315 performs a further check to determine whether the web page 325 can be served from the browser's cache 140, 145 and if so informs the browser to serve the page from the cache 140, 145 rather than requesting the page from the server 130.

In one embodiment the web server 130 transmits a workflow map 525 detailing the various navigation paths that can be navigated from a particular web page 325. In this embodiment the state management component 405 on receiving the map 525 traverses the map 525 to locate the next node (page) that can be navigated to. If the state management component 405 also needs to consider state variables, the state management component 405 can use these variables to filter out nodes on the workflow map 525 and thus locating the exact web page 325 to navigate to.

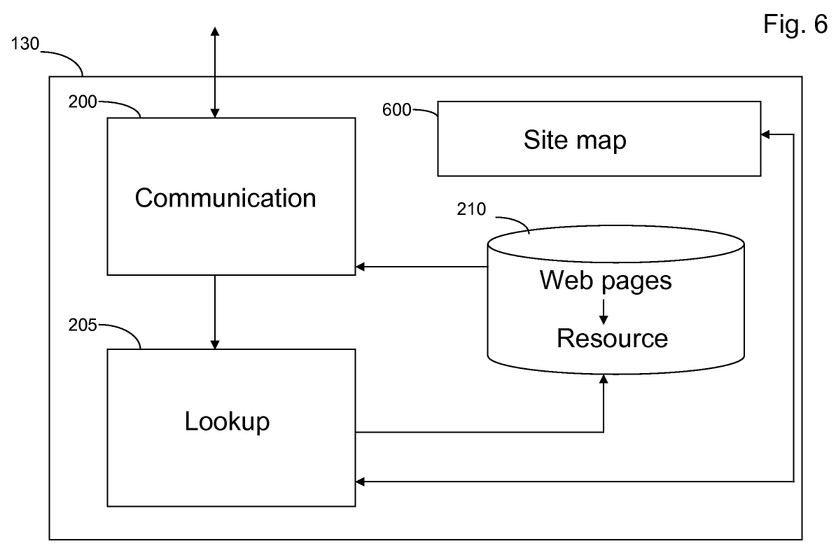

In another embodiment the web server 130 sends back the URL of the next web page 325 the user can navigate to. Thus in this embodiment several requests to the web server 130 need to be made over the course of the user's browsing session and modifications will be need to be made to the web server 130 in order for the web server 130 to determine the next page to navigate to. Referring to FIG. 6 a prior art web server 130 is shown (FIG. 3). In this embodiment the web server 130 comprises a site map component 600. The site map component 600 comprises a map of pages located on the web server 130. Each page comprises details about each of the possible navigational paths from the page. Thus, the web server 130 receives requests from client devices 105, 110 for the next page to navigate to—whether this is a forward or back navigation operation.

The communication component 200 receives the request from the client device 105, 110. The communication component 200 transmits the request to the lookup component 205 and the lookup component determines if this is the first request that it has received from the client device 105, 110 for this particular page at this particular web site. If the lookup component determines that it is the first request, the lookup component performs a lookup in the site map and parses the site map to determine the next page to navigate to. Once the next page has been located the communication component 200 transmits the address of the next page to the requesting client device 105, 110.

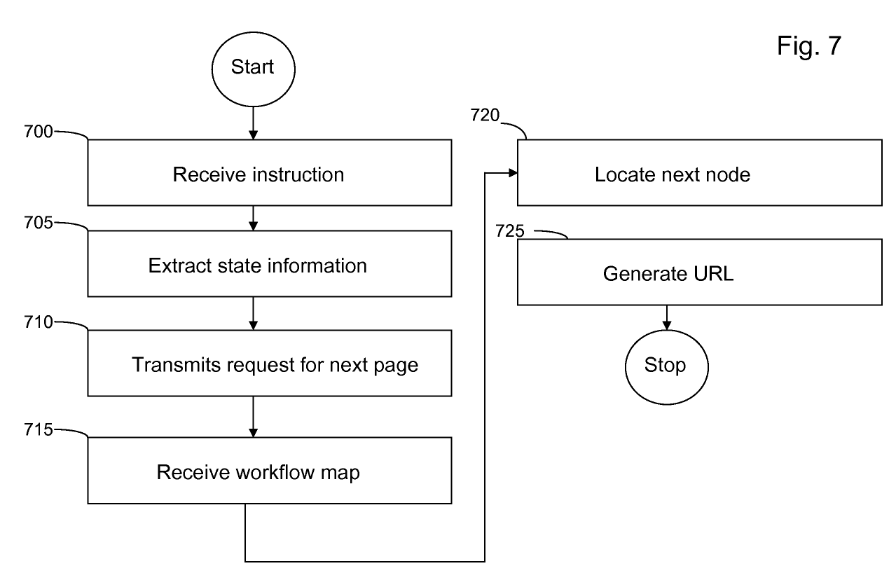

Referring to FIG. 7 a flow chart explains the operational steps of the invention. At step 700 the forward 425 or back navigation 430 components receives a navigational request from their respective forward 310 or back button 315 located within the browser interface 300. At step 705, the forward 310 or back 315 navigation components generates a call function requesting a URL to be generated for attaching to the forward 310 or back button 315 (depending on which button was selected) in order for the user to use the forward 310 or back button 315 to navigate to the next logic web page 325 in the workflow.

The state management component 405 received the function call at step 710 and extracts state information, for example, the web page the user is currently browsing and from which the user wishes to navigate forward or backwards to and any variables to be considered, for example, the user has selected radio button three etc. The state management component 405 identifies the location of the web server 130 the web page 325 is stored on and transmits a request to the web server 130, via the communication component 410, requesting the next web page the user can navigate to at step 715.

In another embodiment the communication component 200 may also transmit a copy of the site map to the requesting client device 105, 110. Thus, the requesting client device may on future requests, before asking the web server 130 for the address of the next page, perform its own lookup on the site map to determine the address of the next page. It is only if the address of the next page can not be found on the site map does the client device 105, 110 send a request to the web server for the next page.

At step 720, the state management component 405 takes the next web page information either from the workflow map 525 or as a reply from the web server 130 and generates a URL for the next web page 325 to be navigated to. This URL is communicated to the requesting forward 425 or backward navigation 430 button at step 725 and attached to the attributes of the requesting forward 310 or back button 315 at step 725.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium.

Examples of a computer-readable medium include a semiconductor or solid state memory, magnetic tape, a removable computer diskette, a random access memory (RAM), a read-only memory (ROM), a rigid magnetic disk and an optical disk.

Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks.

Modems, cable modem and Ethernet cards are just a few of the currently available types of network adapters.

The description of the present invention has been presented for purposes of illustration and description but is not intended to exhaust or limit the invention in the form disclosed. Many modifications and variations will be apparent to those of ordinary skill in the art. The embodiments were chosen and described in order to best explain the principles of the invention and the practical application, and to enable others of ordinary skill in the art to understand the invention for various embodiments with various modifications as are suited to the particular use contemplated.

1. A context based navigation component for navigating from a first page to a second page within a browser application, the context based navigation component comprising:
a call back function for receiving an instruction to navigate to a second page from an action button operating within the browsing application;
a state management component for determining the attributes of the first page and in response to the determined attributes identifying which second page to navigate to; and
a generation component for generating an address of the determined second page and assigning the generated address to the action button.

2. A context based navigation component as claimed in claim 1, wherein the action button is a forward or back button.

3. A context based navigation component as claimed in claim 1, wherein the state management component determines the attributes of the first page by requesting status information from the call back function.

4. A context based navigation component as claimed in claim 3 wherein the status information comprises the identity of a type and context of data input into the first page.

5. A context based navigation component as claimed in claim 1 wherein the state management component further comprises determining a workflow of a website in order to determine the second page to navigate to.

6. A context based navigation component as claimed in claim 1 wherein the workflow comprises a workflow map depicting a plurality of navigation paths to be navigated to.

7. A context navigation component as claimed in claim 6 wherein if the workflow map does not contain a required navigation path to a second page, then the state management component transmits a request to a server which stores the first page to request the communication of the second page.

8. A context navigation component as claimed in claim 1 further comprising a notifying component for notifying the browser application of an absent data entry of a data entry field of the first page such that the state management component is unable to determined the second page to navigate to until the absent data entry has been remedied.

9. A method for context based navigation for navigating from a first page to a second page within a browser application, the method comprising:
receiving an instruction to navigate to a second page from an action button operating within the browsing application;
determining the attributes of the first page and in response to the determined attributes identifying which second page to navigate to; and
generating an address pertaining of the determined second page and assigning the generated address to the action button.

10. A method as claimed in claim 9, wherein the action button is a forward or back button.

11. A method as claimed in claimed in claim 9, wherein attributes of the first page are determined by requesting status information form a call back function.

12. A method as claimed in claim 11 wherein the status information comprises the identity of a type and context of data input into the first page.

13. A method as claimed in claim 9 further comprises determining a workflow of a website in order to determine the second page to navigate to.

14. A method as claimed in claim 9 wherein the workflow comprises a workflow map depicting a plurality of navigation paths to be navigated to.

15. A method as claimed in claim 14 wherein if the workflow map does not contain a required navigation path to a second page, a request is transmitted to a server which stores the first page to request the communication of the second page.

16. A method as claimed in claim 15 further comprising notifying the browser application of an absent data entry of a data entry field of the first page such that the second page to navigate to can not be determined until the absent data entry has been remedied.

17. A computer program product comprising a recordable computer readable medium loadable into the internal memory of a digital computer, comprising software code portions which when executed by a processor perform a method of context based navigation for navigating from a first page to a second page within a browser application, the method comprising:
receiving an instruction to navigate to a second page from an action button operating within the browsing application;
determining the attributes of the first page and in response to the determined attributes identifying which second page to navigate to; and
generating an address pertaining of the determined second page and assigning the generated address to the action button.
